(19) United States
(12) Patent Application Publication
(10) Pub. No.: US 2010/0118140 A1
(43) Pub. Date: May 13, 2010

(54) PARKING ASSISTING APPARATUS AND METHOD

(75) Inventors: Hideyuki Iwakiri, Gifu (JP); Yasushi Makino, Shizuoka (JP); Yuuichi Kubota, Aichi (JP); Tomohiko Endo, Aichi (JP); Miyuki Omori, Aichi (JP); Yukiko Kawabata, Aichi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/444,777

(22) PCT Filed: Feb. 13, 2008
(86) PCT No.: PCT/JP2008/052343

§ 371 Date: Apr. 8, 2009

(30) Foreign Application Priority Data
Feb. 16, 2007 (JP) 2007-036917

(51) Int. Cl. H04N 7/18

(52) U.S. Cl. 348/135; 348/E07.085

(57) ABSTRACT

A disclosed parking assisting apparatus can determine the angle of the own vehicle to be changed at the time of parking in a parking space by precisely estimating the direction of the parking space next to a parked vehicle. The parking assisting apparatus 10A, 10B for assisting tandem type parking of a vehicle in a parking space next to a parked vehicle comprises distance data acquiring means 70 for acquiring distance data representing a distance between an own vehicle and a plurality of points on a side of the parked vehicle when the own vehicle passes on the side of the parked vehicle, said parked vehicle existing on a proximal side of the parking space in a traveling direction of the own vehicle; and inclination angle calculating means 12A, 12B for calculating an inclination angle which is an angle of the traveling direction of the own vehicle with respect to the side of the parked vehicle, based on the distance data acquired by the distance data acquiring means; wherein said apparatus is configured to determine an angle to be changed at the time of parking in the parking space in a tandem type parking manner, based on the inclination angle calculated by the inclination angle calculating means.

### TECHNICAL FIELD

The present invention relates to a parking assisting apparatus and method for assisting parallel type parking or tandem type parking of a vehicle in a parking space next to a parked vehicle.

### BACKGROUND ART

JP2003-270344 A discloses a parking assisting apparatus for assisting parallel type parking comprising distance measuring means for detecting distance information between an own vehicle and a target object to be detected, parking space detecting means for detecting a parking space in which the own vehicle can be parked, target object side detecting means for detecting a side of the target object which would become substantially parallel to the side of the own vehicle if the own vehicle were parked in the parking space, and parking direction determining means for determining a target parking direction in which the own vehicle should be oriented when the own vehicle is parked in the parking space.

However, in fact, since the side of the parked vehicle which exists next to the parking space for parallel type parking is typically substantially perpendicular to a traveling direction of the own vehicle, it is difficult to detect the side of the parked vehicle with a distance-measuring sensor when the own vehicle passes in front of the parked vehicle. Thus, according to the configuration disclosed in JP2003-270344 A, because the side of the parked vehicle cannot be detected with a distance-measuring sensor or it cannot be detected with high accuracy even if it can be detected, there is a problem that it is not possible to precisely estimate the direction of the parking space next to the parked vehicle.

### DISCLOSURE OF INVENTION

Therefore, an object of the present invention is to provide a parking assisting apparatus which can determine the angle of an own vehicle to be changed at the time of parking in a parking space by precisely estimating the direction of the parking space next to a parked vehicle.

In order to achieve the aforementioned objects, according to the first aspect of the present invention, a parking assisting apparatus for assisting tandem type parking of a vehicle in parking space next to a parked vehicle is provided which comprises;

distance data acquiring means for acquiring distance data representing respective distances between an own vehicle and a plurality of points on a side of the parked vehicle when the own vehicle passes on the side of the parked vehicle, said parked vehicle existing on a proximal side of the parking space in a traveling direction of the own vehicle; and

inclination angle calculating means for calculating an inclination angle which is an angle of the traveling direction of the own vehicle with respect to the side of the parked vehicle, based on the distance data acquired by the distance data acquiring means;

wherein said apparatus is configured to determine an angle of the own vehicle to be changed at the time of parking in the parking space in a tandem type parking manner, based on the inclination angle calculated by the inclination angle calculating means.

According to the second aspect of the present invention, a parking assisting apparatus for assisting parallel type parking of a vehicle in a parking space next to a parked vehicle is provided which comprises;

distance data acquiring means for acquiring distance data representing respective distances between an own vehicle and a plurality of points on a front surface of the parked vehicle when the own vehicle passes in front of the parked vehicle, said parked vehicle existing on a proximal side of the parking space in a traveling direction of the own vehicle; and

inclination angle calculating means for calculating an inclination angle which is an angle of the traveling direction of the own vehicle with respect to the front surface of the parked vehicle, based on the distance data acquired by the distance data acquiring means;

wherein said apparatus is configured to determine an angle of the own vehicle to be changed at the time of parking in the parking space in a parallel type parking manner, based on the inclination angle calculated by the inclination angle calculating means.

According to the third aspect of the present invention, in the first or the second aspect of the present invention,

if a parking section line or road partition line adjacent to the parking space is recognized by image recognition processing, the inclination angle calculating means calculates the angle of the traveling direction of the own vehicle with respect to the recognized parking section line or road partition line.

According to the fourth aspect of the present invention, a parking assisting apparatus for assisting tandem type parking of a vehicle in a parking space next to a parked vehicle is provided which is configured to calculate an angle of a traveling direction of an own vehicle with respect to a side of the parked vehicle, based on distance data which is representing respective distances between the own vehicle and a plurality of points on the side of the parked vehicle and is acquired when the own vehicle passes on the side of the parked vehicle which exists on a proximal side of the parking space in a traveling direction of the own vehicle, and said apparatus is configured to determine an angle of the own vehicle to be changed at the time of parking in the parking space in a tandem type parking manner, based on the calculated angle.

According to the fifth aspect of the present invention, a parking assisting apparatus for assisting parallel type parking of a vehicle in a parking space next to a parked vehicle is provided which is configured to calculate an angle of a traveling direction of an own vehicle with respect to a front surface of the parked vehicle, based on distance data which is representing respective distances between the own vehicle and a plurality of points on the front surface of the parked vehicle and is acquired when the own vehicle passes in front of the parked vehicle which exists on a proximal side of the parking space in a traveling direction of the own vehicle, and said apparatus is configured to determine an angle of the own vehicle to be changed at the time of parking in the parking space in a parallel type parking manner, based on the calculated angle.

According to the present invention, a parking assisting apparatus is provided which can determine the angle of the own vehicle to be changed at the time of parking in the parking space by precisely estimating the direction of the parking space next to the parked vehicle.

### BRIEF DESCRIPTION OF THE DRAWINGS

These and other objects, features, and advantages of the present invention will become more apparent from the following detailed description of preferred embodiments given with reference to the accompanying drawings, in which:

FIG. 1 is a system diagram of an embodiment of a parking assisting apparatus 10A according to the first embodiment;

FIG. 2 is a diagram for illustrating how the distance-measuring sensor 70 detects the parked vehicle Z;

FIG. 3 is a diagram for illustrating the row of points related to the parked vehicle Z which can be obtained when the vehicle (own vehicle) with the distance-measuring sensor 70 runs near parked vehicle Z with an inclination angle;

FIG. 4 is a flowchart of a main process for implementing a parking space direction estimation algorithm related to tandem type parking;

FIG. 5 is a plan view illustrating a certain situation of the parking area for tandem type parking;

FIG. 6 is a flowchart of a main process for implementing a parking space direction estimation algorithm related to parallel type parking;

FIG. 7 is a plan view illustrating a certain situation of the parking area for parallel type parking;

FIG. 8 is a diagram for illustrating an example of a screen for setting a target parking position, and etc., for tandem type parking;

FIG. 9 is a system diagram of an embodiment of a parking assisting apparatus 10B according to the second embodiment; and

FIG. 10 is a flowchart of a main part of an inclination angle calculation process executed by a parking assisting apparatus 10B according to the second embodiment.

### EXPLANATION FOR REFERENCE NUMBER

10A, 10B parking assisting apparatus
12A, 12B parking assisting ECU
16 steering angle sensor
18 vehicle speed sensor
20 back monitoring camera
22 display
26 image recognition device
30 steering system ECU
50 reverse shift switch
52 parking switch
70 distance-measuring sensor

### BEST MODE FOR CARRYING OUT THE INVENTION

In the following, the best mode for carrying out the present invention will be described in detail by referring to the accompanying drawings.

### First Embodiment

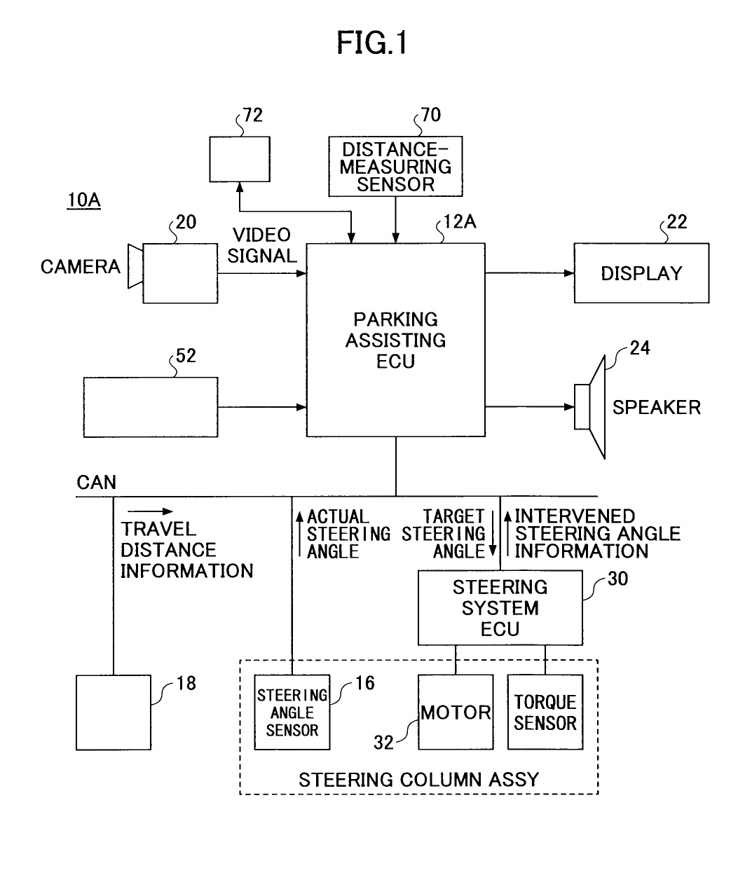

FIG. 1 is a system diagram of an embodiment of a parking assisting apparatus 10A according to the present invention. As shown in FIG. 1, the parking assisting apparatus 10A is comprised mainly of an electronic control unit 12A (hereafter referred to as a parking assisting ECU 12A). The parking assisting ECU 12A is comprised mainly of a microprocessor that includes a CPU, a ROM, a RAM, etc., (not shown) which are interconnected via appropriate buses. In the ROM are stored the computer readable programs to be carried out by the CPU and data.

To the parking assisting ECU 12A are connected a steering angle sensor 16 for detecting the steering angle of the steering wheel (not shown), and a vehicle speed sensor 18 for detecting the speed of the vehicle, via appropriate buses such as a CAN (Controller Area Network) or a high-speed communication bus. The vehicle speed sensor 18 may be wheel speed sensors provided on individual wheels, each of which generates pulse signals according to the rotating speed of the corresponding wheel.

The parking assisting ECU 12A is connected to a distance-measuring sensor 70 which measures the distance with respect to a parked vehicle using sound waves (for example, sonic waves), radio waves (for example, millimeter waves), light waves (for example, lasers), etc. The distance-measuring sensor 70 may be any means which can detect a distance such as a stereo vision camera, other than laser radar, millimeter wave radar, and sonic wave sonar, for example. The distance-measuring sensor 70 is provided on either side of the front body of the vehicle.

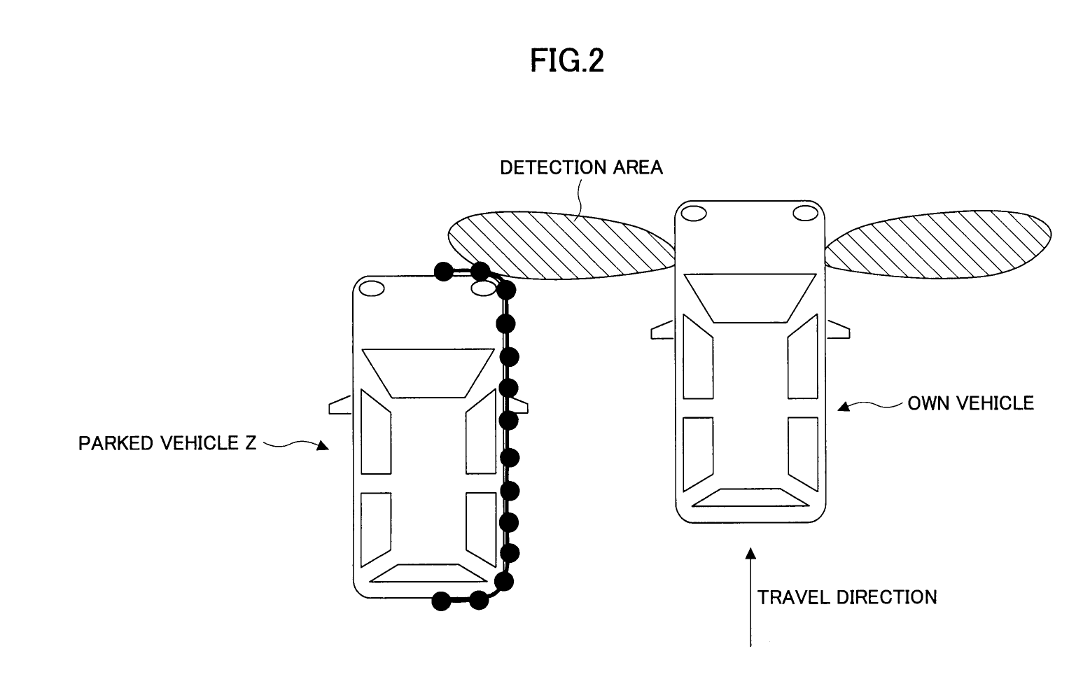

The distance-measuring sensor 70 detects the distance with respect to the parked vehicle located on the side of the own vehicle by emitting sound waves or the like in a predetermined area, and then receiving the reflected waves, as shown in FIG. 2. The distance-measuring sensor 70 may be disposed near a bumper of the front body of the vehicle and may emit sound waves or the like in a slanting forward direction which forms an angle ranging from 17 degrees to 20 degrees with respect to the lateral direction of the vehicle, for example.

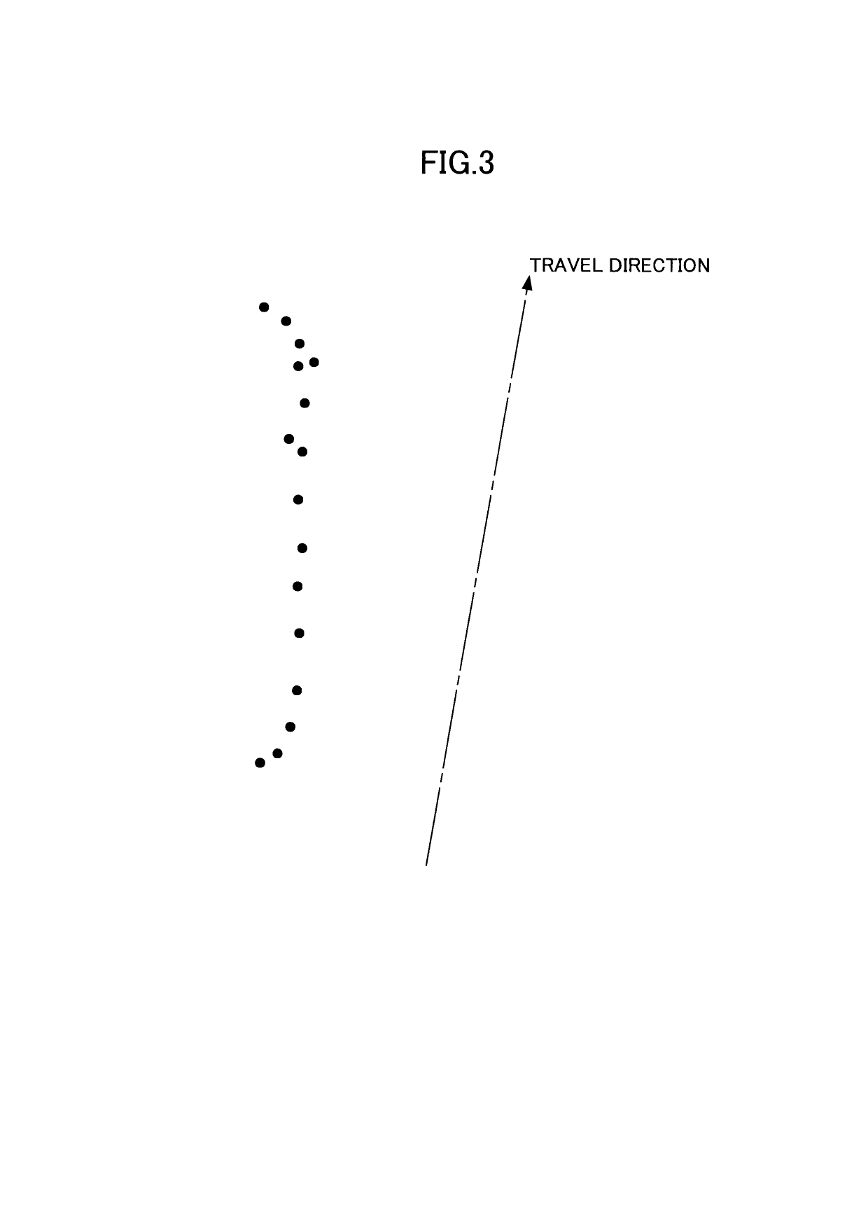

FIG. 3 is a diagram for illustrating the row of points related to the parked vehicle Z which can be obtained when the vehicle (own vehicle) with the distance-measuring sensor 70 runs near the parked vehicle Z in FIG. 2. The distance-measuring sensor 70 may output a row of points (i.e., a group comprised of reflected points of the sound wave) representing reflections from portions of the parked vehicle, as shown in FIG. 3. The output data may be stored periodically in a memory 72 (for example, EEPROM).

The parking assisting ECU 12A is also connected to a reverse shift switch 50 and a parking switch 52. The reverse shift switch 50 outputs an ON signal when a shift lever is shifted to the reverse position and otherwise outputs an OFF signal. The parking switch 52 is provided in the cabin of the vehicle so as to allow a user in the cabin to operate it. The parking switch 52 outputs an OFF signal in its normal state and outputs an ON signal when operated by the user.

The parking assisting ECU 12A determines whether the user needs assistance in parking the vehicle based on the output signal of the parking switch 52. It is noted that the parking switch 52 may include a switch for specifying parallel type parking or tandem type parking. In this case, the parking assisting ECU 12A operates in a parking mode (i.e., parallel type parking mode or tandem type parking mode) according to the specified parking mode.

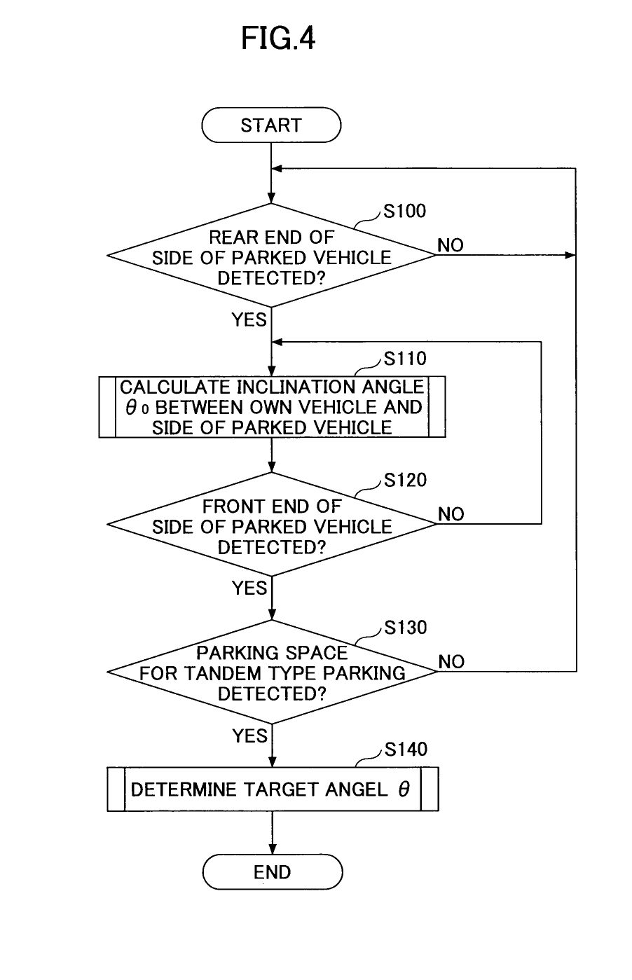

FIG. 4 is a flowchart of a main process for implementing a parking space direction estimation algorithm related to tandem type parking. It is noted that the processing routine shown in FIG. 4 may be initiated when the parking switch 52 is turned on and tandem type parking mode is specified, and may be repeated at a predetermined period.

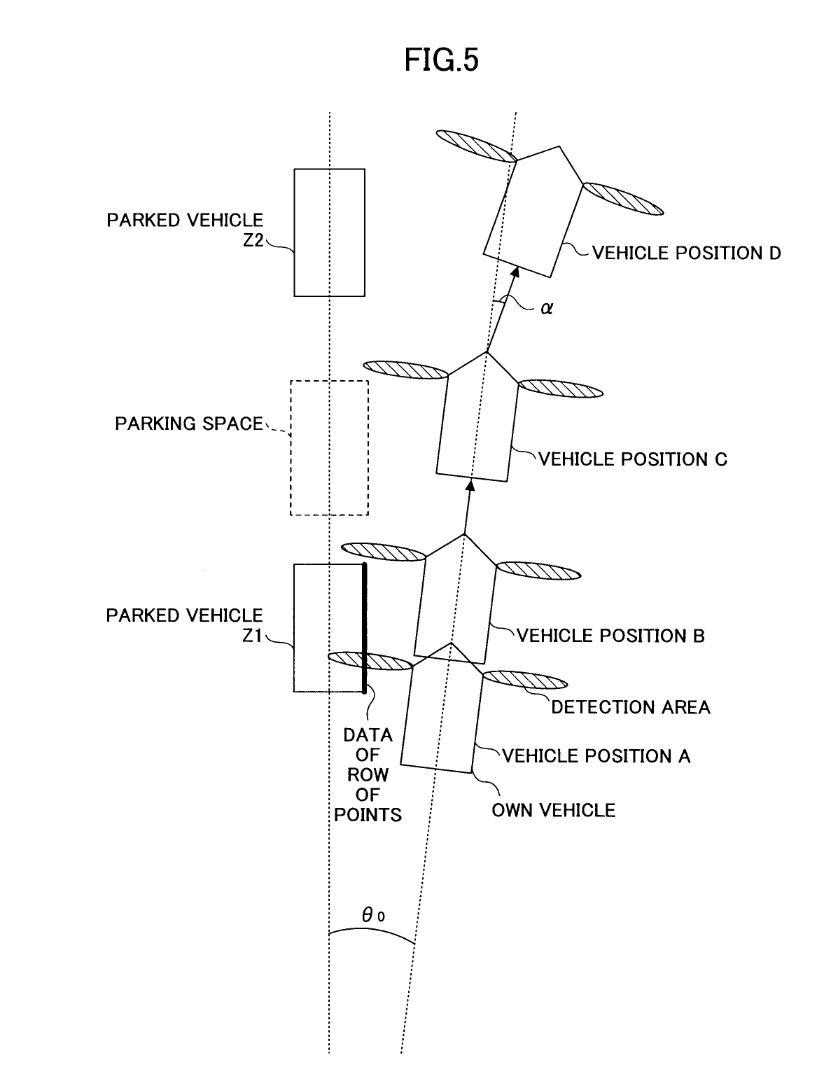

FIG. 5 is a diagram for illustrating a parking space direction estimation algorithm corresponding to FIG. 4, and is a plan view illustrating a certain situation of the parking area. Here, a situation of the parking area in which the parked vehicles Z1 and Z2 are parked next to the parking space is assumed, as shown in FIG. 5. Further, in FIG. 5, it is assumed that the vehicle (i.e., own vehicle) passes on the side of the parked vehicles Z1 and Z2 (and thus the parking space between them) in the traveling direction indicated by the arrows in the drawing.

Referring to FIG. 4, at first, in step 100, the parking assisting ECU 12A determines whether a rear end of the side of the parked vehicle is detected, based on the detection results (i.e., row of points representing distance with respect to the side of the parked vehicle) of the distance-measuring sensor 70. For example, the parking assisting ECU 12A determines that the rear end of the side of the parked vehicle is detected when the length of the row of points becomes longer than or equal to 2 m. In the example shown in FIG. 5, the rear end of the side of the parked vehicle Z1 may be detected when the own vehicle proceeds to the vehicle position A. If the rear end of the side of the parked vehicle is detected, the process routine goes to step 110. Otherwise the process routine returns to 100 without executing any further process at this execution period.

In step 110, the parking assisting ECU 12A calculates the inclination angle θ0 with respect to the detected parked vehicle. The inclination angle θ0 is an angle between a traveling direction of the own vehicle when the own vehicle passes on the side of the parked vehicle and the side of the parked vehicle (or fore-and-aft direction of the parked vehicle), in the case of the tandem type parking, as shown in FIG. 5. The traveling direction of the own vehicle when the own vehicle passes on the side of the parked vehicle may be a traveling direction of the own vehicle at an appropriate point between when the rear end of the side of the parked vehicle is detected and when the front end of the side of the parked vehicle is detected. In the illustrated example in FIG. 5, the traveling direction of the own vehicle when the own vehicle passes on the side of the parked vehicle may be a traveling direction of the own vehicle at an appropriate point between the vehicle position A and the vehicle position B. The traveling direction varies as the travel distance of the own vehicle changes unless the own vehicle travels in a straight line. However, hereafter, the position of the own vehicle corresponding to the traveling direction used to calculate the inclination angle θ0 is referred as to as “reference position”.

The inclination angle θ0 is derived from the detection results (i.e., row of points representing distance with respect to the side of the parked vehicle) of the distance-measuring sensor 70, utilizing a fact that the side of the parked vehicle can be approximated by a line or second-order curve with small curvature. If the liner approximation is applied to the side of the parked vehicle, the inclination angle θ0 may be derived from the direction of the approximated line, and if the second-order curve approximation is applied to the side of the parked vehicle, the inclination angle θ0 may be derived from the direction perpendicular to the center axis of the approximated second-order curve. It is noted that in an alternative embodiment the approximation of functions other than the second-order curve approximation can be applied as long as the principal axis is determined and another approximation way using a pattern can be applied.

In subsequent step 120, the parking assisting ECU 12A determines whether a front end of the side of the parked vehicle is detected, based on the detection results of the distance-measuring sensor 70. For example, the parking assisting ECU 12A determines that the front end of the side of the parked vehicle is detected, if the row of points whose length is longer than a predetermined length (>2.0 m) is detected and then no row of points can be detected for a length longer than or equal to 50 cm. In the example shown in FIG. 5, the front end of the side of the parked vehicle may be detected when the own vehicle proceeds to the vehicle position B. If the front end of the side of the parked vehicle is detected, the process routine goes to step 130. Otherwise the process routine returns to step 110. Thus, the parking assisting ECU 12A may continue to calculate the inclination angle θ0 based on the detection results of the distance-measuring sensor 70 obtained periodically within a interval from the time when the rear end of the side of the parked vehicle is detected to the time when the front end of the side of the parked vehicle is detected. This is because the detection accuracy of the direction of the side of the parked vehicle (and thus the accuracy of the inclination angle θ0) becomes higher as the length of the row of points becomes longer. It is noted that at a stage when the front end of the side of the parked vehicle has been detected the parking assisting ECU 12A may calculate the inclination angle θ0 based on the detection results of the distance-measuring sensor 70 obtained collectively within an interval from the time when the rear end of the side of the parked vehicle is detected to the time when the front end of the side of the parked vehicle is detected. In any case, in the illustrated example in FIG. 5, the parking assisting ECU 12A may calculate the inclination angle θ0 with respect to the side of the parked vehicle Z1 based on the data of the row of points related to the side of the parked vehicle Z1.

In step 130, the parking assisting ECU 12A determines whether a parking space for tandem type parking is detected, based on the detection results of the distance-measuring sensor 70. For example, the parking assisting ECU 12A determines that the parking space for tandem type parking is detected if the row of points whose length is 2.0 m is detected and then no row of points can be detected for a length longer than or equal to 6 m. In the illustrated example in FIG. 5, the parking space may be detected when the own vehicle proceeds to the vehicle position C. If it is determined that the parking space is detected, the process routine goes to step 140. Otherwise the process routine returns to step 100, determining that there is no parking space available on the distal side of the parked vehicle detected this time. In the latter case, in next step 100, it will be determined whether a rear end of a side of a new parked vehicle will be detected.

In step 140, the parking assisting ECU 12A calculates an angle of the vehicle to be changed in performing tandem type parking in the parking space detected in step 130, based on the inclination angle θ0 calculated in step 110, and determines the calculated angle as a target angle θ. The target angle θ is calculated as follows, for example.

θ=θ0+α

Here, α is a amount of change in orientation of the own vehicle after the reference position, and is referred as to a deflection angle α. The deflection angle α is calculated based on respective outputs of the steering angle sensor 16 and vehicle speed sensor (see FIG. 1) obtained after the reference position. It is noted that hereafter the sign of the deflection angle α is defined as such that a positive sign corresponds to the clockwise direction and a negative sign corresponds to the counter clockwise direction. Here, in general, the deflection angle α can be calculated by the following formula (1), using minute travel distance ds of the vehicle and curvature γ of roads (γ corresponds to the reciprocal of cornering radius R of the vehicle). According to this formula (1), the amount of change in orientation of the vehicle generated within a travel distance of βm which corresponds to a section from the reference position to the current vehicle position is calculated as the deflection angle α.

$$α = {\int }_{- β}^{0} γ \cdot d s \qquad ( 1 )$$

In fact, the parking assisting ECU 12A of the present embodiment calculates minute deflection angle αᵢ at every predetermined distance (0.5 m, in this example) based on the following formula (2) which is transformed formula (1) and calculates the deflection angle α by summing the calculated respective minute deflection angles α_{1˜k}.

$$α = {\sum }_{i = 1}^{k} {α}_{i} , {α}_{i} = {\int }_{- 0.5}^{0} γ \cdot d s \qquad ( 2 )$$

At this time, the predetermined distance (0.5 m, in this example) is monitored by integrating in time the output signals of the vehicle speed sensor (i.e., wheel speed pulses). Further, road curvature γ is determined based on the steering angle Ha obtained from the steering angle sensor 16, using the relationship γ==Ha/L·η (where L is the length of the wheelbase, and η is an overall gear ratio of the vehicle, that is to say, the ratio of the steering angle Ha to the steering angle of the wheel), for example. It is noted that the minute deflection angle αᵢ may be calculated, for instance, by multiplying the road curvature γ obtained every 0.01 m of minute travel distance by that minute travel distance 0.01 m, and integrating these multiplied values obtained every 0.05 m of travel distance. It is noted that the relationship between the road curvature γ and the steering angle Ha may be stored in the ROM of the parking assisting ECU 12A in the form of a map generated based on correlation data obtained in advance on a vehicle type basis.

In this manner, when the parking space for tandem type parking is detected, the parking assisting ECU 12A calculates the angle (i.e., the target angle θ) of the vehicle to be changed in performing tandem type parking in the parking space. Then, when the parking assisting ECU 12A has calculated the target angle θ, the parking assisting ECU 12A performs parking assist control according to various situations based on the calculated target angle θ. The parking assist control may include not only assistance after the parking start position (for example, assistance in setting a target parking position, vehicle control such as steering control when the vehicle rolls backward for the parking space, etc.), but also assistance before the parking start position (for example, information output to the driver such as guidance message for guiding the vehicle to an appropriate parking start position, steering assistance for making the orientation of the vehicle appropriate at the parking start position, etc). In the case of the configuration in which only the assistance after the parking start position is performed, the target angle θ may be calculated when the vehicle arrives at the parking start position (when the reverse shift switch 50 is turned on). In the case of the configuration in which assistance before the parking start position is performed, the parking assisting ECU 12A may calculate the target angle θ periodically before the vehicle arrives at the parking start position, and perform steering assistance or the like for making the target angle θ fall within an appropriate range.

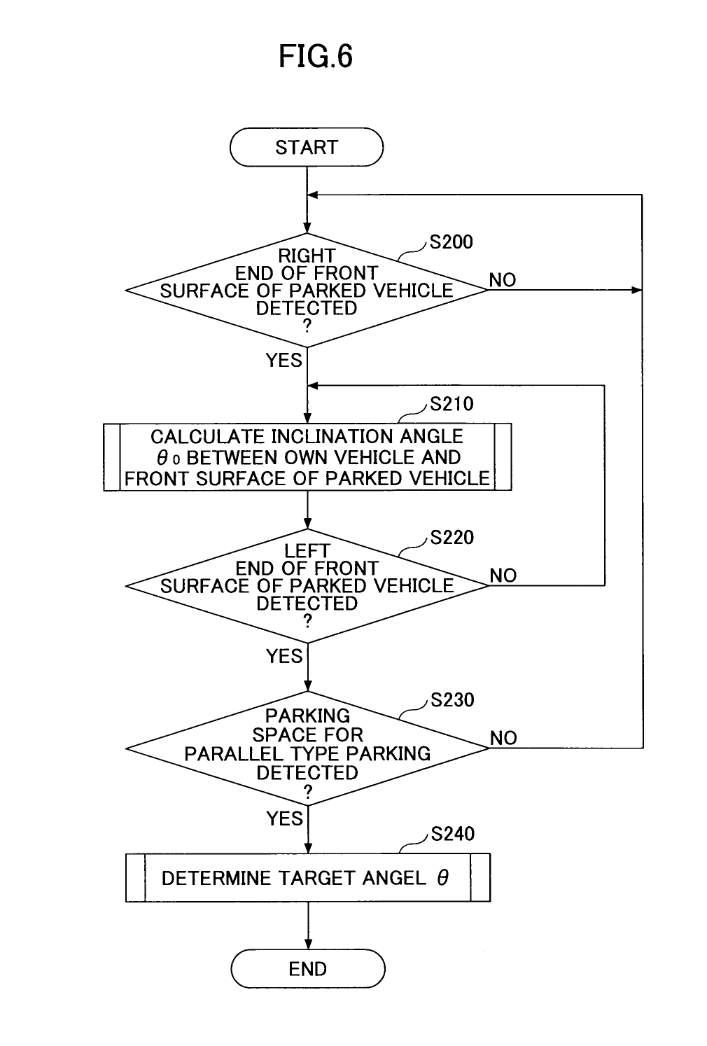

FIG. 6 is a flowchart of a main process for implementing a parking space direction estimation algorithm related to parallel type parking. It is noted that the processing routine shown in FIG. 6 may be initiated when the parking switch 52 is turned on and the parallel type parking mode is specified, and may be repeated at a predetermined period.

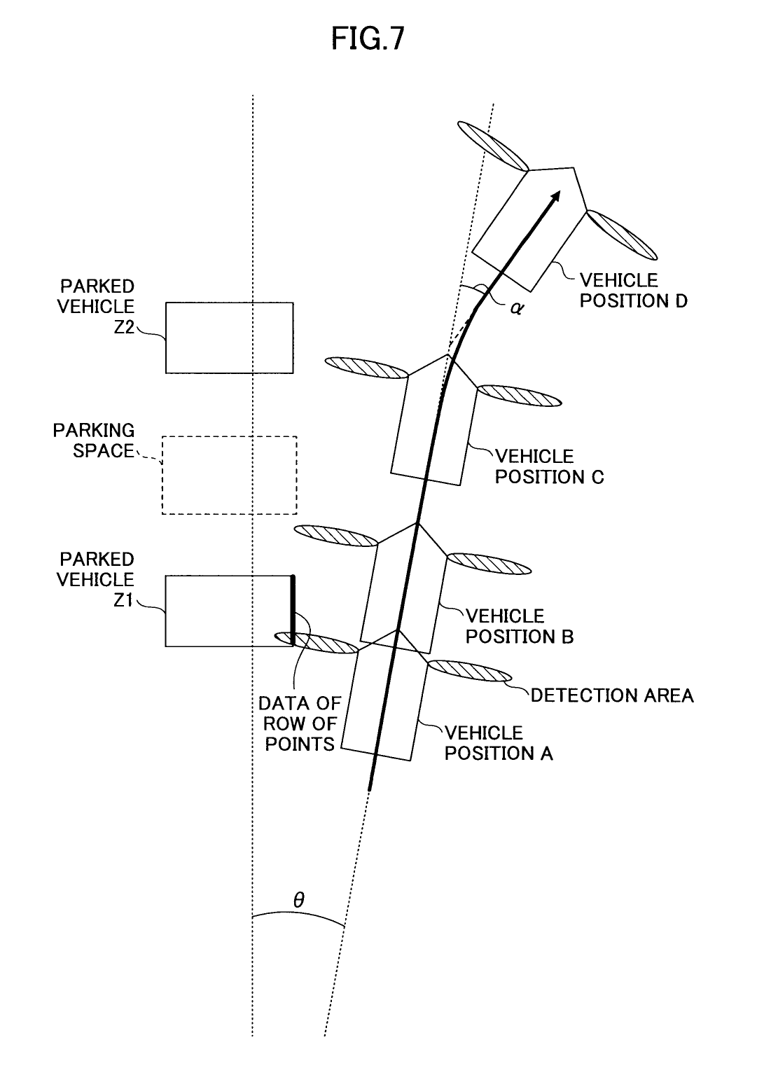

FIG. 7 is a diagram for illustrating a parking space direction estimation algorithm corresponding to FIG. 6, and is a plan view illustrating a certain situation of the parking area. Here, a situation of the parking area in which the parked vehicles Z1 and Z2 are parked next to the parking space on the left side of the own vehicle is assumed, as shown in FIG. 7. Further, in FIG. 5, it is assumed that the vehicle (i.e., own vehicle) passes in front of the parked vehicles Z1 and Z2 (and thus the parking spaces between them) in the traveling direction indicated by the arrow in the drawing.

Referring to FIG. 6, at first, in step 200, the parking assisting ECU 12A determines whether a right end of the front surface (i.e., a proximal end in the traveling direction) of the parked vehicle is detected, based on the detection results (i.e., row of points representing distance with respect to the front of the parked vehicle) of the distance-measuring sensor 70. For example, the parking assisting ECU 12A determines that the right end of the front surface of the parked vehicle is detected when the length of the row of points becomes longer than or equal to 1 m. In the example shown in FIG. 7, the right end of the front surface of the parked vehicle Z1 may be detected when the own vehicle proceeds to the vehicle position A. If the right end of the front surface of the parked vehicle is detected, the process routine goes to step 210. Otherwise the process routine returns to 200 without executing any further process at this execution period.

In step 210, the parking assisting ECU 12A calculates the inclination angle θ0 with respect to the detected parked vehicle. The inclination angle θ0 is an angle between a traveling direction of the own vehicle when the own vehicle passes in front of the parked vehicle and the front surface of the parked vehicle (or lateral axis of the parked vehicle), in the case of the parallel type parking, as shown in FIG. 7. The traveling direction of the own vehicle when the own vehicle passes in front of the parked vehicle may be a traveling direction of the own vehicle at an appropriate point between when one end of the front portion of the parked vehicle is detected and when the other end of the front portion of the parked vehicle is detected. In the illustrated example in FIG. 7, the traveling direction of the own vehicle may be a traveling direction at an appropriate point between the vehicle position A and the vehicle position B. The traveling direction varies as the travel distance of the own vehicle changes unless the own vehicle travels in a straight line. However, hereafter, the position of the own vehicle corresponding to the traveling direction used to calculate the inclination angle θ0 is referred to as “reference position”. The inclination angle θ0 is derived from the detection results (i.e., row of points representing distance with respect to the front portion of the parked vehicle) of the distance-measuring sensor 70, utilizing a fact that the front portion of the parked vehicle can be approximated to a ellipse or second-order curve with large curvature.

In subsequent step 220, the parking assisting ECU 12A determines whether a left end of the front surface (i.e., a distal end in the traveling direction) of the parked vehicle is detected, based on the detection results of the distance-measuring sensor 70. For example, the parking assisting ECU 12A determines that the left end of the front surface of the parked vehicle is detected if the row of points whose length is 1 m is detected and then no row of points can be detected for a length longer than or equal to 50 cm. In the example shown in FIG. 7, the left end of the front surface of the parked vehicle Z1 may be detected when the own vehicle proceeds to the vehicle position B. If the left end of the front surface of the parked vehicle is detected, the process routine goes to step 230. Otherwise the process routine returns to step 210. Thus, the parking assisting ECU 12A may continue to calculate the inclination angle θ0 based on the detection results of the distance-measuring sensor 70 obtained periodically within a interval from the time when the right end of the front surface of the parked vehicle is detected to the time when the left end of the front surface of the parked vehicle is detected. This is because the detection accuracy of the direction of the front surface of the parked vehicle (and thus the accuracy of the inclination angle θ0) becomes higher as the length of the row of points becomes longer. It is noted that at a stage when the left end of the front surface of the parked vehicle has been detected the parking assisting ECU 12A may calculate the inclination angle θ0 based on the detection results of the distance-measuring sensor 70 obtained collectively within a interval from the time when the right end of the front surface of the parked vehicle is detected to the time when the left end of the front surface of the parked vehicle is detected. In any case, in the illustrated example in FIG. 7, the parking assisting ECU 12A may calculate the inclination angle θ0 with respect to the front surface of the parked vehicle Z1 based on the data of the row of points related to the front surface of the parked vehicle Z1.

In step 230, the parking assisting ECU 12A determines whether a parking space for parallel type parking is detected, based on the detection results of the distance-measuring sensor 70. For example, the parking assisting ECU 12A determines that the parking space is detected if the row of points whose length is 1.0 m is detected and then no row of points can be detected for a length longer than or equal to 2 m. In the illustrated example in FIG. 7, the parking space may be detected when the own vehicle proceeds to the vehicle position C. If it is determined that the parking space is detected, the process routine goes to step 240. Otherwise the process routine returns to step 200, determining that there is no parking space available on the distal side of the parked vehicle detected this time. In the latter case, in next step 200 it will be determined whether a right end of a front surface of a new parked vehicle will be detected.

In step 240, the parking assisting ECU 12A calculates an angle of the vehicle to be changed in performing parallel type parking in the parking space detected in step 230, based on the inclination angle θ0 calculated in step 210, and determines the calculated angle as a target angle θ. The target angle θ is calculated as follows, for example.

θ=90−(θ0+α)

Here, α is the deflection angle α explained above (see FIG. 7), and the way of calculating the deflection angle α may be the same as the way mentioned above.

In this manner, when the parking space for parallel type parking is detected, the parking assisting ECU 12A calculates the target angle θ of the vehicle to be changed in performing parallel type parking in the parking space. Then, when the parking assisting ECU 12A has calculated the target angle θ, the parking assisting ECU 12A performs parking assist control according to various situations based on calculated target angle θ. The parking assist control may include not only assistance after the parking start position, but also assistance before the parking start position. In the case of the configuration in which only the assistance after the parking start position is performed, the target angle θ may be calculated when the vehicle arrives at the parking start position (when the reverse shift switch 50 is turned on). In the case of the configuration in which assistance before the parking start position is performed, the parking assisting ECU 12A may calculate the target angle θ periodically before the vehicle arrives at the parking start position, and perform steering assistance or the like for making the target angle θ fall within an appropriate range.

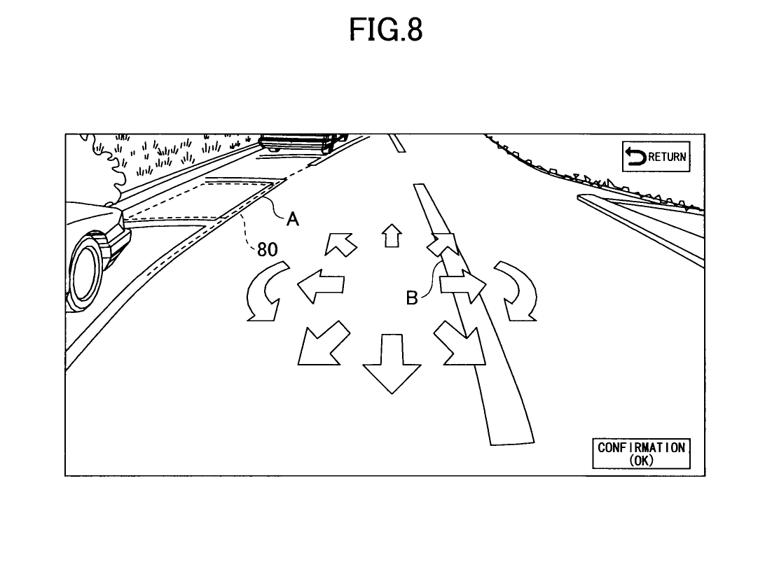

Next, the parking assist which may be performed when the vehicle rolls backward from the parking start position to the parking space is explained with reference to FIGS. 8 and 1.

When the reverse shift switch 50 is turned on in the parking start position, the parking assisting ECU 12A displays the image (real image) captured by the back monitoring camera 20, which images a scene behind the vehicle with a predetermined viewing angle, on the display 22 provided in the cabin. Then, a target parking frame 80 is superposed on the captured image on the display 22, as shown in FIG. 8 (screen for tandem type parking). The target parking frame 80 may be a pictorial display which imitates an actual parking frame or an outside shape of the vehicle. For example, the target parking frame 80 has a form whose position and direction users can recognize.

The initial position of the target parking frame 80 displayed on the display 22 is determined based on the positional relationship between the parking space and the parking start position. On the other hand, the initial direction of the target parking frame 80 displayed on the display 2 is determined based on the target angle θ calculated as mentioned above. In this case, the initial direction of the target parking frame 80 is determined to be substantially parallel to the side of the parked vehicle. The initial position and direction of the target parking frame 80 (corresponds to the target parking position and the target parking direction, respectively) may be confirmed by the user as they are, when the user operates a confirmation switch, for example. Or, the position and direction of the target parking frame 80 may be adjusted with touch switches, etc., for moving the target parking frame in lateral and longitudinal directions and in directions of rotation, as shown in FIG. 8, before operating the confirmation switch.

When the position and direction of the target parking frame are confirmed, the parking assisting ECU 12A determines the target parking position and the target parking direction based on the position and direction of the confirmed target parking frame 80, and determines a target track based on the determined target parking position and target parking direction. When the vehicle starts to roll backward, the parking assisting ECU 12A estimates the position of the vehicle during the parking assist control using the travel distance of the vehicle derived from the output signals of the vehicle speed sensor 18 and the steering position derived from the output signals of the steering angle sensor 16. Then, the parking assisting ECU 12A calculates a target steering angle as a function of the amount of departure of the estimated vehicle position from the target track. The parking assisting ECU 12A transmits the calculated target steering angle to the steering system ECU 30. The steering system ECU 30 controls the motor 32 so as to implement the target steering angle. The motor 32 may be disposed in a steering column for rotating a steering shaft by its rotating angle. The parking assisting ECU 12A requests the driver to stop the vehicle (or controls the vehicle to stop automatically using the automatic braking system) when the vehicle finally arrives at the target parking position in the target parking direction within the parking space, and then terminates the parking assist control.

According to the first embodiment described above, the following effect among others can be obtained.

As mentioned above, since the inclination angle θ0 with respect to the parked vehicle on the proximal side of the parking space is calculated and the target angle θ is calculated by taking the calculated inclination angle θ0 into consideration, it becomes possible to calculate the target angle θ with high accuracy even if the own vehicle doesn't pass in parallel with the side or front surface of the parked vehicle as shown in FIG. 5 and FIG. 7. Correspondingly, the accuracy of the initial direction of the target parking frame 80 displayed on the display 2 improves, and enables reducing the user's burden of adjusting operations of the target parking frame 80. Furthermore, since only the inclination angle θ0 with respect to the parked vehicle on the proximal side of the parking space is used, it is possible to calculate the target angle θ with high accuracy even if there is no parked vehicle on the distal side of the parking space. This is useful in the case of the parallel type parking in particular, because a driver tends to turn the vehicle toward the parking start position immediately after the vehicle passes the parked vehicle on the proximal side, and thus there may be the case in which it is difficult to calculate the inclination angle AO between the own vehicle and the parked vehicle on the distal side of the parking space.

### Second Embodiment

The second embodiment differs from the above first embodiment mainly in that the inclination angle θ0 used to calculate the target angle θ is calculated using image recognition results of a parking section line or road partition line in addition to the detection results (i.e., row of points representing distance with respect to the side of the parked vehicle) of the distance-measuring sensor 70. In the following, arrangements unique to the second embodiment are described intensively, but other configurations may be the same as those in the above first embodiment. Further, elements which may be the same as the corresponding elements are given the same reference numerals and their explanations are omitted.

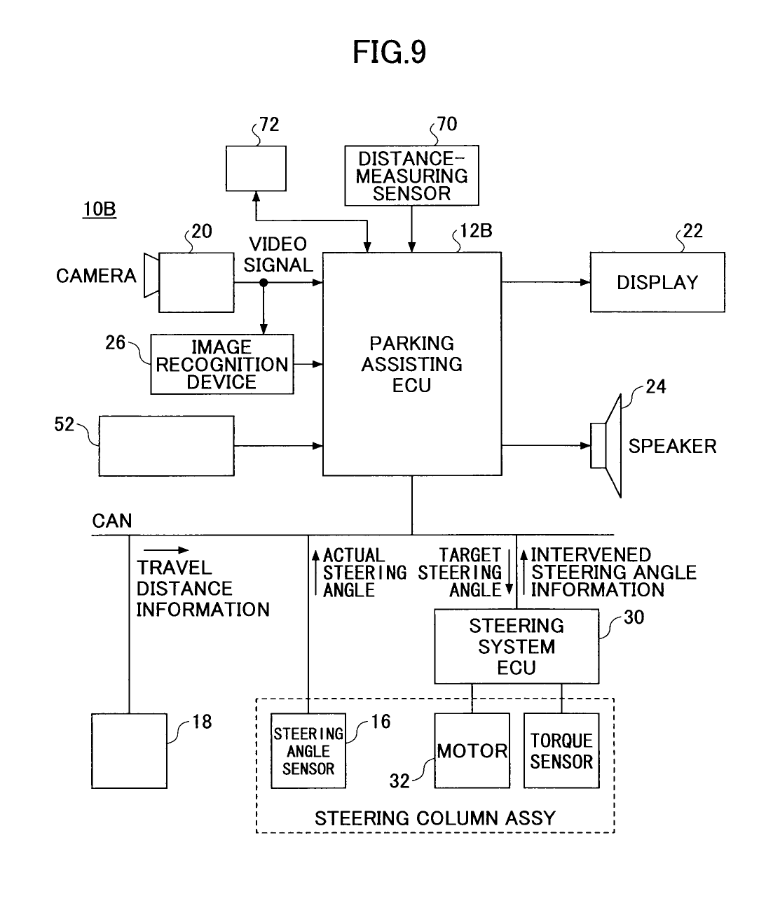

FIG. 9 is a system diagram of an embodiment of a parking assisting apparatus 10B according to the second embodiment. The parking assisting apparatus 10B differs from the parking assisting apparatus 10A according to the first embodiment shown in FIG. 1 in that an image recognition device 26 is added in terms of hardware configuration.

The image recognition device 26 recognizes white lines painted around the parking space by performing image processing of the captured image of the back monitoring camera 20. The white line may be a line A of the parking section line located at the inlet side as shown in FIG. 8 or a road partition line B (i.e., a center line in the illustrated example in FIG. 8).

Here, an example of the process for recognizing the parking section line is described. In this example, feature points are extracted in the ROI in the captured image. The feature points are extracted as points at which the rate of change of luminance exceeds a predetermined value. In other word, edges (i.e., outlines) which are defined by a steep change in brightness are extracted. Then coordinates of the respective pixels are converted from the local coordinate system of the camera to the real coordinate system by distortion correction. Then, liner approximation is applied to the edges (i.e., grouping of the feature points) to derive the outlines of the feature points. Then the outline of the feature points which has an angle (i.e., an inclination angle) smaller than or equal to a predetermined angle (an acute angle) with respect to the fore-and-aft direction of the vehicle is detected as a parking section line (which is typically a white line).

When the image recognition device 26 can recognize such a white line, the image recognition device 26 supplies the parking assisting apparatus 10B with information representative of the direction of the recognized white line (or an angle of the own vehicle with respect to the recognized white line).

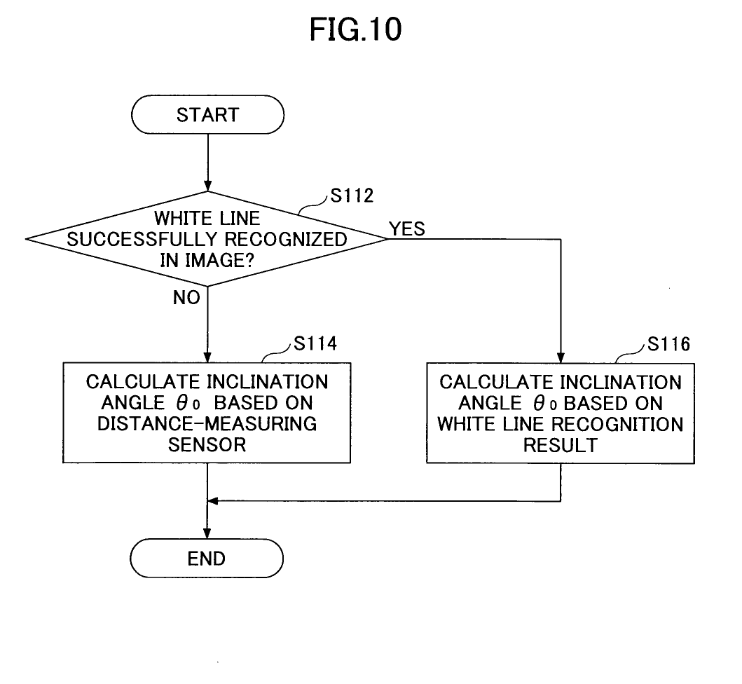

FIG. 10 is a flowchart of a main part of an inclination angle calculation process executed by a parking assisting apparatus 10B according to the second embodiment. The process routine shown in FIG. 10 is executed as the process of step 110 shown in FIG. 4 or the process of step 210 shown in FIG. 6.

In step 112, the parking assisting apparatus 10B determines whether the white line around the parking space is successfully recognized by image recognition, based on the image recognition results obtained from the image recognition device 26. Here, the case where the parking section line in the image is not successfully recognized may be the case where the parking section line cannot be recognized due to influence of insufficient light at night, underground parking area, etc. (i.e., influence on extraction of the edges), the positional relationship between the actual parking section line and the coverage of the back monitoring camera 20, snow cover, etc., or the fact that the parking section line doesn't exist in the first place. In step 112, if the image recognition of the white line is successfully performed, the process routine goes to step 114, while if the image recognition of the white line is not successfully performed, the process routine goes to step 116.

In step 114, the parking assisting apparatus 10B calculates the inclination angle θ0 based on the detection results of the distance-measuring sensor 70, as is the case with the above first embodiment.

In step 116, the parking assisting apparatus 10B calculates the inclination angle θ0 based on the image recognition results of the white line obtained from the image recognition device 26. In this case, the inclination angle θ0 may be calculated as an angle between the direction of the white line in the captured image and the fore-and-aft direction of the own vehicle.

The inclination angle θ0 calculated in this way is utilized effectively in determining the target angle θ, as is the case with the above first embodiment.

According to the second embodiment described above, the following effect, among others, can be obtained.

According to the second embodiment, it is possible to determine the target angle θ adapted to the parking section line, even in a situation where the parked vehicle is parked in a biased manner within the parking section line, for example, because the inclination angle θ0 based on the detection results of the white line of the image recognition device 26 is utilized with a higher priority than the inclination angle θ0 based on the detection results of the distance-measuring sensor 70.

The present invention is disclosed with reference to the preferred embodiments. However, it should be understood that the present invention is not limited to the above-described embodiments, and variations and modifications may be made without departing from the scope of the present invention.

For example, although in the above-described embodiments various applications are initiated when the parking switch 52 is turned on, the present invention is not limited to this configuration. For example, they may be initiated if the vehicle speed is lower than a predetermined speed and it is determined that the vehicle position is located in the parking area based on the map data of a navigation device, even in the condition where the parking switch 52 is not turned on. In this case, such a configuration where there is no parking switch 52 can be contemplated.

Further, although in the above-described embodiments the distance-measuring sensor 70 which is suited to detect the side of the parked vehicle is used, it is also possible to detect the side of the parked vehicle (and thus the inclination angle θ0) based on image recognition using a camera.

Further, although in the above-described embodiments the target angle θ is merely used to determine the initial display direction of the target parking frame 80 and the final target parking direction is determined based on the direction of the target parking frame 80 after its orientation adjusting operation, the present invention is not limited to such a configuration. For example, the final target parking direction may be determined directly based on the target angle θ if there is no function of adjusting the orientation of the target parking frame 80.

The present application is based on Japanese Priority Application No. 2007-036917, filed on Feb. 16, 2007, the entire contents of which are hereby incorporated by reference.

1. A parking assisting apparatus for assisting tandem type parking of a vehicle in parking space next to a parked vehicle, comprising:
distance data acquiring means for acquiring distance data representing respective distances between an own vehicle and a plurality of points on a side of the parked vehicle when the own vehicle passes on the side of the parked vehicle, said parked vehicle existing on a proximal side of the parking space in a traveling direction of the own vehicle; and
inclination angle calculating means for calculating an inclination angle which is an angle of the traveling direction of the own vehicle with respect to the side of the parked vehicle, based on the distance data acquired by the distance data acquiring means;
wherein said apparatus is configured to determine an angle of the own vehicle to be changed at the time of parking in the parking space in a tandem type parking manner, based on the inclination angle calculated by the inclination angle calculating means.

2. A parking assisting apparatus for assisting parallel type parking of a vehicle in parking space next to a parked vehicle, comprising:
distance data acquiring means for acquiring distance data representing respective distances between an own vehicle and a plurality of points on a front surface of the parked vehicle when the own vehicle passes on a front of the parked vehicle, said parked vehicle existing on a proximal side of the parking space in a traveling direction of the own vehicle; and
inclination angle calculating means for calculating an inclination angle which is an angle of the traveling direction of the own vehicle with respect to the front surface of the parked vehicle, based on the distance data acquired by the distance data acquiring means;
wherein said apparatus configured to determine an angle of the own vehicle to be changed at the time of parking in the parking space in a parallel type parking manner, based on the inclination angle calculated by the inclination angle calculating means.

3. The parking assisting apparatus as claimed in claim 1, wherein if a parking section line or road partition line adjacent to the parking space is recognized by image recognition process, the inclination angle calculating means calculates the angle of the traveling direction of the own vehicle with respect to the recognized parking section line or road partition line.

4. A parking assisting apparatus for assisting tandem type parking of a vehicle in a parking space next to a parked vehicle, wherein
said apparatus is configured to calculate an angle of a traveling direction of an own vehicle with respect to a side of the parked vehicle, based on distance data which is representing respective distances between the own vehicle and a plurality of points on the side of the parked vehicle and is acquired when the own vehicle passes on the side of the parked vehicle which exists on a proximal side of the parking space in a traveling direction of the own vehicle, and said apparatus is configured to determine an angle of the own vehicle to be changed at the time of parking in the parking space in a tandem type parking manner, based on the calculated angle.

5. A parking assisting apparatus for assisting parallel type parking of a vehicle in a parking space next to a parked vehicle, wherein
said apparatus is configured to calculate an angle of a traveling direction of an own vehicle with respect to a front surface of the parked vehicle, based on distance data which is representing respective distances between the own vehicle and a plurality of points on the front surface of the parked vehicle and is acquired when the own vehicle passes on a front of the parked vehicle which exists on a proximal side of the parking space in a traveling direction of the own vehicle, and said apparatus is configured to determine an angle of the own vehicle to be changed at the time of parking in the parking space in a parallel type parking manner, based on the calculated angle.
